(19) United States
(12) Patent Application Publication
(10) Pub. No.: US 2016/0130986 A1
(43) Pub. Date: May 12, 2016

(54) POWER CONDITIONING AND ENERGY STORAGE DEVICE USING HYDRAULIC-PNEUMATIC SEQUENTIALLY FIRED PULSE FORMING NETWORKS

(71) Applicant: Board of Regents, The University of Texas System, Austin, TX (US)

(72) Inventors: Joaquin M. Campos, Austin, TX (US); Raul G. Longoria, Austin, TX (US); Mark T. Crawford, Los Alamos, NM (US)

(21) Appl. No.: 14/927,043

(22) Filed: Oct. 29, 2015

Related U.S. Application Data
(60) Provisional application No. 62/074,280, filed on Nov. 3, 2014.

(51) Int. Cl. F01K 27/00; F15B 1/027; F15B 1/26

(52) U.S. Cl. CPC F01K 27/005; F15B 1/26; F15B 1/027; F15B 2201/411; F15B 2201/305

(57) ABSTRACT

The present invention includes a mechanical energy storage device and method of making and using the same comprising: two or more pneumatic or hydraulic capacitors or accumulators, each of them connected to at least one hydraulic or pneumatic exhaust manifold and a hydraulic or pneumatic intake manifold through exhaust and intake valves, respectively; at least one hydraulic fluid or pneumatic reservoir in fluid communication with the hydraulic or pneumatic exhaust manifold via a hydraulic or pneumatic motor connected to an output device, and in fluid communication with the hydraulic or pneumatic intake manifold via hydraulic pump or pneumatic compressor driven by a source of variable power; and a governor or control valve disposed between the hydraulic or pneumatic exhaust manifold and the hydraulic or pneumatic motor connected to the output device. The use of compressible gas, pneumatic, and air are interchangeable for the purposes of this device.

### CROSS-REFERENCE TO RELATED APPLICATIONS

This application claims benefit of U.S. Provisional Application Ser. No. 62/074,280 filed Nov. 3, 2014 which is incorporated herein by reference in its entirety.

### STATEMENT OF FEDERALLY FUNDED RESEARCH

This invention was made with U.S. Government support by the U.S. Army grant number W911QX-07-D-0002. The government has certain rights in this invention.

### TECHNICAL FIELD OF THE INVENTION

The present invention relates in general to the field of energy storage, and more particularly, to a closed-loop mechanical energy storage device.

### BACKGROUND OF THE INVENTION

Without limiting the scope of the invention, its background is described in connection with mechanical energy storage options.

Most commonly, intermittent sources of energy are connected to an energy storage device that can accumulate energy without regard to the input source. For example, wind, wave and solar energy reach daily minimums and maximums during various times of the day or depending on wind conditions.

One common storage system is compressed air energy storage (CAES), which is a robust energy storage method. Certain advantages can be found in CAES systems, including good storage capacity dwell time, well-understood dynamic characteristics, and high charge and discharge cycle life. However, the systems have to compensate for the variation in pressure within the CAES systems, which provide somewhat variable outputs.

Another method converts the wind, wave or solar energy into electrical energy by charging electro-chemical energy storage devices commonly known as batteries. While batteries provide a mostly clean output, electro-chemical energy storage devices have two distinct disadvantages: a very high weight and limited duty cycle. Thus, what is needed is a robust system that provides a very clean energy output, with a long duty cycle and a reduced weight.

### SUMMARY OF THE INVENTION

In one embodiment, the present invention includes a mechanical energy storage device comprising: two or more pneumatic or hydraulic capacitors or accumulators, each of them connected to at least one hydraulic or pneumatic exhaust manifold and a hydraulic or pneumatic intake manifold through exhaust and intake valves, respectively; at least one hydraulic fluid or pneumatic reservoir in fluid communication with the hydraulic or pneumatic exhaust manifold via a hydraulic or pneumatic motor connected to an output device, and in fluid communication with the hydraulic or pneumatic intake manifold via hydraulic pump or pneumatic compressor driven by a source of variable power; and a governor or control valve disposed between the hydraulic or pneumatic exhaust manifold and the hydraulic or pneumatic motor connected to the output device. In one aspect, the two or more pneumatic or hydraulic capacitors or accumulators form a mechanical pulse forming network by linking pneumatic or hydraulic capacitors or accumulators together that are fired in sequence. In another aspect the compressible fluid (gas) confined in the pneumatic or hydraulic capacitors or accumulators acts as a spring when compressed by the hydraulic fluid or gas being pumped into the pneumatic or hydraulic capacitors or accumulators. In another aspect, the gas or hydraulic fluid is forced out of the pneumatic or hydraulic capacitors or accumulators through the outlet valves to drive the hydraulic or pneumatic motor. In another aspect, the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the air or hydraulic capacitors or accumulators are connected by high pressure lines. In another aspect, the hydraulic fluid reservoir is open to the atmosphere. In another aspect, the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the hydraulic or pneumatic capacitors or accumulators, the exhaust or intake valves, or the governor or control valve, are plastic. In another aspect, the output device driven by the hydraulic or pneumatic motor under the control of the governor or control valve provides a high quality power pulse to load. In another aspect, the source of variable power that drives the hydraulic pump or pneumatic compressor is at least one of solar, wind, wave, stored potential energy, springs, pendulums, stored water, or weights. In another aspect, the output device is a generator, a compressor, a pump, a shaft, a drive train, a chain, a rotary compressor or generator, a reciprocating compressor or generator, a centrifugal compressor or generator, or an axial compressor or generator. In another aspect, the at least one of the governor, the exhaust and the intake valves are actively or passively controlled.

In another embodiment, the present invention includes a method of converting stored mechanical energy into a high quality power pulse to load comprising: connecting two or more pneumatic or hydraulic capacitors or accumulators, each of them connected to at least one hydraulic or pneumatic exhaust manifold and a hydraulic or pneumatic intake manifold through exhaust and intake valves, respectively; providing at least one hydraulic fluid or pneumatic reservoir in fluid communication with the hydraulic exhaust manifold via a hydraulic or pneumatic motor connected to an output device, and in fluid communication with the hydraulic or pneumatic intake manifold via hydraulic pump or pneumatic compressor driven by a source of variable power; and controlling the high quality power pulse to load by a governor or control valve disposed between the hydraulic or pneumatic exhaust manifold and the hydraulic or pneumatic motor connected to the output device. In one aspect, the two or more pneumatic or hydraulic capacitors or accumulators form a mechanical pulse forming network by linking pneumatic or hydraulic capacitors or accumulators together that are fired in sequence. In another aspect the compressible fluid (gas) confined in the pneumatic or hydraulic capacitors or accumulators acts as a spring when compressed by the hydraulic fluid or gas being pumped into the pneumatic or hydraulic capacitors or accumulators. In another aspect, the gas or hydraulic fluid is forced out of the pneumatic or hydraulic capacitors or accumulators through the outlet valves to drive the hydraulic or pneumatic motor. In another aspect, the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the air or hydraulic capacitors or accumulators are connected by high pressure lines. In another aspect, the hydraulic fluid reservoir is open to the atmosphere if it is a hydraulic system. In another aspect, the at least one of the hydraulic or pneumatic exhaust manifold, the hydraulic pneumatic intake manifold, the hydraulic fluid or pneumatic reservoir, the hydraulic or pneumatic motor, the hydraulic pump or pneumatic compressor of the air or hydraulic capacitors or accumulators, the exhaust or intake valves, or the governor or control valve, are plastic. In another aspect, the output device driven by the hydraulic or pneumatic motor under the control of the governor or control valve provides a high quality power pulse to load. In another aspect, the source of variable power that drives the hydraulic pump or pneumatic compressor is at least one of solar, wind, wave, stored potential energy, springs, pendulums, stored water, or weights. In another aspect, the output device is a generator, a compressor, a pump, a shaft, a drive train, a chain, a rotary compressor or generator, a reciprocating compressor or generator, a centrifugal compressor or generator, or an axial compressor or generator. In another aspect, the at least one of the governor, the exhaust and the intake valves are actively or controlled.

Yet another embodiment of the present invention includes a mechanical energy storage device comprising: two or more pneumatic or hydraulic capacitors or accumulators, each of them connected to at least one hydraulic or pneumatic exhaust manifold and a hydraulic or pneumatic intake manifold through exhaust and intake valves, respectively; at least one hydraulic fluid or pneumatic reservoir in fluid communication with the hydraulic or pneumatic exhaust manifold via a hydraulic or pneumatic motor connected to an output device, and in fluid communication with the hydraulic or pneumatic intake manifold via hydraulic pump or pneumatic compressor driven by a source of variable power; and a governor or control valve disposed between the hydraulic or pneumatic exhaust manifold and the hydraulic or pneumatic motor connected to the output device, wherein the governor, the exhaust and the intake valves are actively or passively controlled, wherein the two or more pneumatic or hydraulic capacitors or accumulators form a mechanical pulse forming network by linking pneumatic or hydraulic capacitors or accumulators together that are fired in sequence and gas confined in pneumatic or hydraulic capacitors or accumulators acts as a spring when compressed by the hydraulic fluid or gas being pumped into the pneumatic or hydraulic capacitors or accumulators. In one aspect, the gas or hydraulic fluid is forced out of the pneumatic or hydraulic capacitors or accumulators through the outlet valves to drive the hydraulic or pneumatic motor. In another aspect, the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the air or hydraulic capacitors or accumulators are connected by high pressure lines. In another aspect, the hydraulic fluid reservoir is open to the atmosphere. In another aspect, the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the air or hydraulic capacitors or accumulators, the exhaust or intake valves, or the governor or control valve, are plastic. In another aspect, the output device driven by the hydraulic or pneumatic motor under the control of the governor or control valve provides a high quality power pulse to load. In another aspect, the source of variable power that drives the hydraulic pump is at least one of solar, wind, wave, stored potential energy, springs, pendulums, stored water, or weights.

In yet another embodiment, the present invention also includes a mechanical energy storage device kit comprising: two or more pneumatic or hydraulic capacitors or accumulators; at least one hydraulic or pneumatic exhaust manifold; a hydraulic or pneumatic intake manifold through exhaust and intake valves, respectively; at least one hydraulic fluid or pneumatic reservoir; at least one fluid hose that connects the hydraulic or pneumatic exhaust manifold to a hydraulic or pneumatic motor or pump; an output device capable of connecting to the hydraulic or pneumatic motor or pump; at least one fluid hose that connects the hydraulic or pneumatic intake manifold via hydraulic pump or pneumatic compressor driven by a source of variable power; a governor or control valve that can be connected between the hydraulic or pneumatic exhaust manifold and the hydraulic or pneumatic motor connected to the output device; and instructions to assemble the mechanical energy storage device.

### BRIEF DESCRIPTION OF THE DRAWINGS

For a more complete understanding of the features and advantages of the present invention, reference is now made to the detailed description of the invention along with the accompanying figures and in which:

FIG. 1 shows a traditional energy storage device of the prior art.

FIG. 2 shows one embodiment of the present invention.

FIG. 3 shows the present invention in more detail.

FIG. 4 shows four separate graphs that each provide a separate output from the various pneumatic or hydraulic accumulators and their combined output in a pulse mode of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

This device is a novel combination of two distinct techniques that provide effective and robust power conditioning for renewable energy capture devices like wind turbines and photovoltaic systems. This method combines the robust energy storage of compressed air energy storage (CAES) and the pulsed power super position technique of sequentially fired pulse forming networks, which together provide a simple and robust power conditioning technique insensitive to power input quality and having a well-characterized and controllable output. The use of compressible gas, pneumatic, and air are interchangeable for the purposes of this device.

Current power conditioning topologies rely on some form of power electronics (integrated circuit logic, high power switching, etc.) in order to perform their intended function. The proposed device differs from the state in the art in that it does not use power electronics for the basic power conditioning of renewable energy input. Rather power conditioning is done by a combination of two things. The first is a buffer action that is characteristic to the proposed energy storage technique. The second is the pulsed manner in which power is released from the energy storage device allowing it to provide a consistent and uniform output for specified durations of time based on the sizing and design of the system. Furthermore although the proposed device may act as an intermediate energy storage, which augments primary chemical energy storage, it is capable of providing standalone power, if sized properly to the load. This eliminates the need for electro-chemical energy storage common in renewable energy systems.

The present invention is, thus, a highly adaptable dual purpose energy storage and power conditioning topology that uses a hydro-pneumatic implementation of a Sequentially Fired Pulsed Forming Network (SFPFN) allowing for the effective interconnection of renewable energy and low quality power sources to loads requiring quality power in off grid applications.

More particularly, the present invention uses a combined hydraulic-pneumatic energy storage system to provide intermediate energy storage for the purposes of load leveling and power conditioning. The maximized use of intermittent input power for constant and known load applications. The advantages of the present invention include that it allows for multi source power input and it is insensitive to quality of power input. Furthermore, the devices and methods taught herein are capable of providing a shaped power output that can be application/load specific, increased energy storage charge cycle life, there is no dump load necessary for “excess” power generation and stores all input, as allowed by the system efficiency and sizing. Importantly, the present invention has the distinct advantage that it can be configured into a passive system with high simplicity, but is also robust, lightweight and/or weight efficient.

The present invention maximizes the use of small renewable energy capture devices whose inputs are highly variable by storing the intermittent input of energy and providing a consistent and known output. The device is ideal for systems that are of constant load cyclic use like refrigeration and enclosed environmental control at remote locations where the use of low power renewable energy sources are highly desired.

The present invention overcomes critical problems with current energy storage devices, by providing: (a) pulsed power source for remote constant load cyclic use devices; (b) simple repair and maintenance requiring few specialized parts; (c) eliminates need for separate primary energy storage (i.e., lead acid batteries) if system is sized correctly; (d) accepts any power input capable of providing shaft power and produces a clean power out; (e) eliminates the need for power conditioning power electronics when sized appropriately and used for specific applications such as pulsed power source/or remote constant load cyclic use devices; and (f) is an environmentally benign energy storage method that uses no environmentally harmful substances or methods.

Other advantages of the present invention over current technologies include, but are not limited to: (a) increased energy storage charge cycle life as compared to common storage systems; (b) no dump load necessary for “excess” power generation if sized properly; and (c) highly adaptable input capabilities, allowing/or small and large inputs other systems would reject.

Because of the relatively simple materials, construction, and method of making and using the present invention, users can very easily be trained in both the use and repair of the device. Further, component acquisition, storage, and transportation are greatly simplified versus other energy storage devices. Further, the materials provide for a robust device with a wide range of operational and component tolerance while at the same time providing a consistent and sustainable power output. Finally, its use, footprint, transportation, installation, materials and breakdown are environmentally friendly as the majority if not all the components can be made with or from recyclable material(s).

Additional advantages of the present invention include that: (1) the device provides relatively constant amplitude pulsed output power given stochastic (random) inputs usually associated with renewables; (2) the device is best matched to constant amplitude cyclic loads like refrigeration and communications equipment; (3) the device allows for energy input from a wide range of sources, and (4) the device is a simple system with readily available components that allow(s) for low level maintenance, and operation.

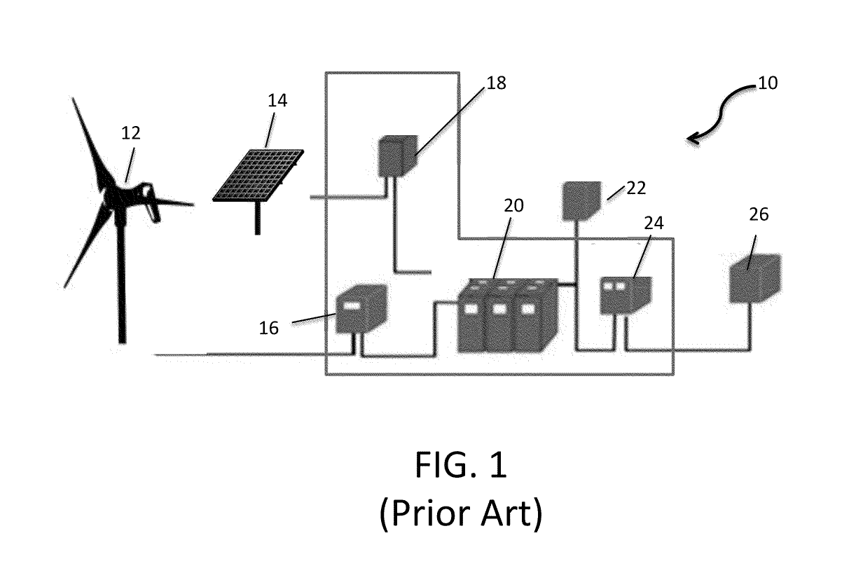

FIG. 1 shows a traditional energy storage device 10 of the prior art. Briefly, wind 12, solar 14, or other energy is captured with a wind charge controlled 16 or a solar charge controller 18, which are then connected to a battery bank 20. The energy stored in the battery bank 20 is then output directly via a DC load 22, or is connected to an inverter 24, the electrical energy is output as an AC load 26.

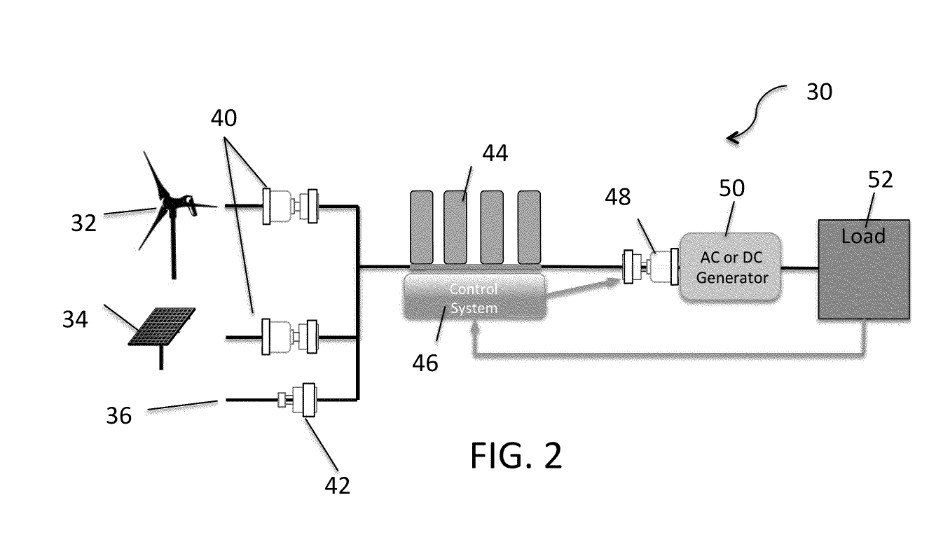

FIG. 2 shows one embodiment of the present invention, in which the device 30 is depicted in conjunction with different stochastic sources of power. For example, the device 30 can be used with wind 32, solar 34, or other sources 36 of kinetic energy (e.g., water pressure), which are connected to electric motors 40 or hydraulic pump or air compressor 42 to provide compression of a gas (or if compressible a liquid) in the one or more air or hydraulic capacitors or accumulators 44, which are depicted in conjunction with control system 46. The output from the one or more air or hydraulic capacitors or accumulators 44 is connected to an output device 48, which is depicted connected to an AC or DC generator 50, which in this example is depicted providing a load 52.

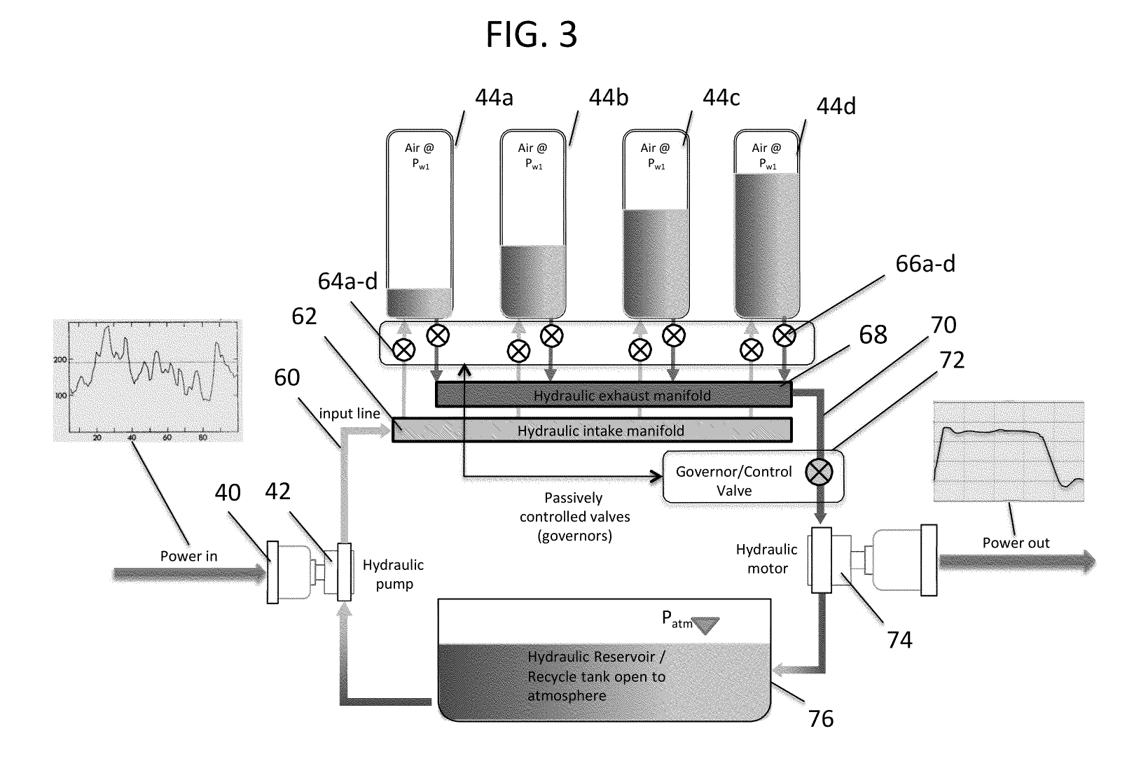

FIG. 3 shows one embodiment of the device 30 of the present invention in more detail. Power in is provided that drives the electric motor 40 which in turn drives the hydraulic pump or air compressor 42, which is connected to a high-pressure input line 60. The electric motor 40 is driven by input from highly variable source like wind or solar as depicted in the graph. An air or hydraulic intake manifold 62 is depicted connected to the high-pressure input line 60, and the hydraulic intake manifold 62 is connected to the air or hydraulic capacitors or accumulators 44a-44d via inlet valves 64a-d. Each of the pneumatic or hydraulic capacitors or accumulators 44a-44d, are then connected to outlet valves 66a-d, which are connected to pneumatic or hydraulic exhaust manifold 68, which is connected to output line 70. A governor/control valve 72 is disposed between the exhaust manifold 70 and a hydraulic or pneumatic motor 74. In this embodiment, an optional hydraulic or pneumatic reservoir 76 is depicted between the hydraulic or pneumatic motor 74 and the hydraulic pump or air compressor 42. The skilled artisan will recognize that the pumps, compressors, motors, generators and/or other devices that transfer potential energy into pneumatic or hydraulic pressure can be interchanged with those depicted in this non-limiting example. In another non-limiting example, the optional hydraulic reservoir 76 can be open to the atmosphere or can optionally be kept under pressure or vacuum, for example, is the system is used as part of, e.g., a closed-loop refrigeration system. As shown in this embodiment, the governor/control valve 72 can be passively controlled or actively controlled, depending on the level of sophistication needed to operate the system and the required output. A feedback loop can also be connected between the power out and the passively/actively controlled valves or governors (64a-d and/or 66a-d) between the manifolds (62 and/or 68) and the air or hydraulic capacitors or accumulators 44a-d.

During the charge phase or in charge mode, the gas confined in pneumatic or hydraulic capacitors or accumulators 44a-44d acts as a “spring” when compressed by hydraulic fluid being pumped in through inlet valve 64a-d into pneumatic or hydraulic capacitors or accumulators 44a-44d.

During the discharge phase, an electric generator or mechanical compressor driven by a hydraulic or pneumatic motor provides high quality power pulse to load shown as output power. A graph above the power out shows the quality of the output. In a discharge or output mode, the gas or hydraulic fluid is forced out of the pneumatic or hydraulic capacitors or accumulators 44a-44d by compressed gas through outlet valves 66a-d.

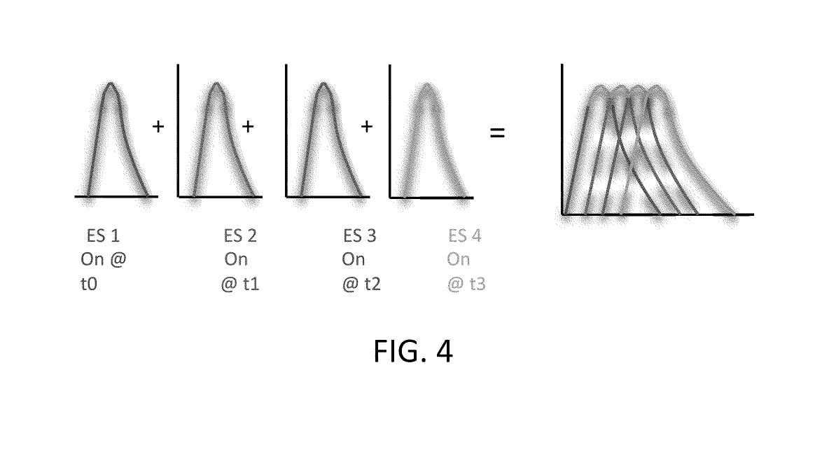

FIG. 4 shows four graphs that represent the controlled release of pressure from, in this example, the four pneumatic or hydraulic capacitors or accumulators 44a-44d, in which a pulse-forming network is created by linking the pneumatic or hydraulic capacitors or accumulators 44a-44d together and are fired in sequence.

Refrigeration Application Example

The present invention can be loaded on an 8 ft.×8 ft.×8 ft. container, with an exterior ambient temperature of 100° F. to interior temperature of 38° F. For this example, the commercial refrigerator used will be a 4.1 kW power unit (Carrier—Transcold Refrigeration unit), at 25% duty cycle (5 minutes out of 20 minutes cont.), and 50% rated power (2.1 KW).

In this example, the power and energy requirements were found to be: Minimum power required −50%×4.1 kW=2.05 kW, Minimum energy required per cycle: 2.1 kW×(5 min/60 min/hr.)=175 W/hr., with a minimum energy input required per hour: 525 W/hr.

Wind Powered Example

Assuming an input from one ˜3 kW rated turbine at 12 mph wind speed daily average each 17 kW-hr/day (Southwest Windpower—Whisper 500) or 700 W-hr/hr. Based on this configuration, the hydro-pneumatic storage system capable of meeting the demand is the following: two banks of four hydro-pneumatic accumulators with a total usable energy storage capacity of 2.1 kW/hr/bank, which is capable of 5 minute pulse of 2.1 kW every 15 minutes continuous, where each hydro-pneumatic accumulator, has an operating pressure of 4,000 pounds per square inch (psi), volume of 4,893 cubic inches, and a high pressure rating of 5,000 psi. The skilled artisan will recognize the ease with which additional units can be added or removed to meet demand. As high-pressure storage tanks can be made from low cost, recyclable and/or lightweight materials, the present invention can be transported easily to remote areas of operation, with minimal to no mechanical equipment needed to place or replace the units. In certain instances the equipment may be enclosed in a structure or could be left outdoors under hot, wet, frozen or other extreme conditions depending on the working fluid (i.e. type of hydraulic fluid and species of compressible gas), and the pressurization of the pneumatic or hydraulic capacitors or accumulators and/or the reservoir or recycle tank(s).

A comparison of the prior art system and the present invention is shown in Table 1, below.

TABLE 1
Comparison of the prior art system and the present invention.

| Battery Systems | Hydro/Pneumatic System |
|---|---|
| Cycle life: 3000 | Cycle life: thousands |
| Energy store life: months | Energy store life: years |
| Power electronics based | Mechanical/passive controls capable |
| EMP susceptible | Not EMP susceptible (w/passive sys.) |
| Some maintenance required | Minimal maintenance required |
| High level repair or replace | Low level repair or replace |
| Requires specialized parts | Commonly available parts |
| Not environmentally benign | Environmentally benign |
| Efficiency in mid to high 90s | Efficiency varies between ~80% to |
| | just over 90% depending on |
| | operating pressure. |

As such, the present invention provides certain distinct advantages over existing systems. First, it is more robust under austere conditions and is easier to transport, assemble, maintain, and operate versus existing systems. Further, it is ideally suited to power constant amplitude cyclic loads like refrigeration, certain lighting applications, and equipment sensitive to power fluctuations such as communications equipment.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A mechanical energy storage device comprising:
two or more pneumatic or hydraulic capacitors or accumulators, each of them connected to at least one hydraulic or pneumatic exhaust manifold and a hydraulic or pneumatic intake manifold through exhaust and intake valves, respectively;
at least one hydraulic fluid or pneumatic reservoir in fluid communication with the hydraulic or pneumatic exhaust manifold via a hydraulic or pneumatic motor connected to an output device, and in fluid communication with the hydraulic or pneumatic intake manifold via hydraulic pump or pneumatic compressor driven by a source of variable power; and
a governor or control valve disposed between the hydraulic or pneumatic exhaust manifold and the hydraulic or pneumatic motor connected to the output device.

2. The device of claim 1, wherein the two or more pneumatic or hydraulic capacitors or accumulators form a mechanical pulse forming network by linking pneumatic or hydraulic capacitors or accumulators together that are fired in sequence.

3. The device of claim 1, wherein the gas confined in the pneumatic or hydraulic capacitors or accumulators acts as a spring when compressed by the hydraulic fluid or gas being pumped into the pneumatic or hydraulic capacitors or accumulators.

4. The device of claim 1, wherein the pneumatic or hydraulic fluid is forced out of the pneumatic or hydraulic capacitors or accumulators through the outlet valves to drive the hydraulic or pneumatic motor.

5. The device of claim 1, wherein the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the air or hydraulic capacitors or accumulators are connected by high pressure lines.

6. The device of claim 1, wherein the hydraulic fluid reservoir is open to the atmosphere.

7. The device of claim 1, wherein the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the pneumatic or hydraulic capacitors or accumulators, the exhaust or intake valves, or the governor or control valve, are plastic.

8. The device of claim 1, wherein the output device driven by the hydraulic or pneumatic motor under the control of the governor or control valve provides a high quality power pulse to load.

9. The device of claim 1, wherein the source of variable power that drives the hydraulic pump or pneumatic compressor is at least one of solar, wind, wave, stored potential energy, springs, pendulums, stored water, or weights.

10. The device of claim 1, wherein the output device is a generator, a compressor, a pump, a shaft, a drive train, a chain, a rotary compressor or generator, a reciprocating compressor or generator, a centrifugal compressor or generator, or an axial compressor or generator.

11. The device of claim 1, wherein the at least one of the governor, the exhaust and the intake valves are passively controlled.

12. A method of converting stored mechanical energy into a high quality power pulse to load comprising:
connecting two or more pneumatic or hydraulic capacitors or accumulators, each of them connected to at least one hydraulic or pneumatic exhaust manifold and a hydraulic or pneumatic intake manifold through exhaust and intake valves, respectively;
providing at least one hydraulic fluid or pneumatic reservoir in fluid communication with the hydraulic or pneumatic exhaust manifold via a hydraulic or pneumatic motor connected to an output device, and in fluid communication with the hydraulic or pneumatic intake manifold via hydraulic pump or pneumatic compressor driven by a source of variable power; and
controlling the high quality power pulse to load by a governor or control valve disposed between the hydraulic or pneumatic exhaust manifold and the hydraulic or pneumatic motor connected to the output device.

13. The method of claim 12, wherein the two or more pneumatic or hydraulic capacitors or accumulators form a mechanical pulse forming network by linking pneumatic or hydraulic capacitors or accumulators together that are fired in sequence.

14. The method of claim 12, wherein the gas confined in pneumatic or hydraulic capacitors or accumulators acts as a spring when compressed by the hydraulic fluid or gas being pumped into the pneumatic or hydraulic capacitors or accumulators.

15. The method of claim 12, wherein the gas or hydraulic fluid is forced out of the pneumatic or hydraulic capacitors or accumulators through the outlet valves to drive the hydraulic or pneumatic motor.

16. The method of claim 12, wherein the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the pneumatic or hydraulic capacitors or accumulators are connected by high pressure lines.

17. The method of claim 12, wherein the hydraulic fluid reservoir is open to the atmosphere.

18. The method of claim 12, wherein the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the pneumatic or hydraulic capacitors or accumulators, the exhaust or intake valves, or the governor or control valve, are plastic.

19. The method of claim 12, wherein the output device driven by the hydraulic or pneumatic motor under the control of the governor or control valve provides a high quality power pulse to load.

20. The method of claim 12, wherein the source of variable power that drives the hydraulic pump or pneumatic compressor is at least one of solar, wind, wave, stored potential energy, springs, pendulums, stored water, or weights.

21. The method of claim 12, wherein the output device is a generator, a compressor, a pump, a shaft, a drive train, a chain, a rotary compressor or generator, a reciprocating compressor or generator, a centrifugal compressor or generator, or an axial compressor or generator.

22. The method of claim 12, wherein the at least one of the governor, the exhaust and the intake valves are passively controlled.

23. A mechanical energy storage device comprising:
two or more pneumatic or hydraulic capacitors or accumulators, each of them connected to at least one hydraulic or pneumatic exhaust manifold and a hydraulic or pneumatic intake manifold through exhaust and intake valves, respectively;
at least one hydraulic fluid or pneumatic reservoir in fluid communication with the hydraulic or pneumatic exhaust manifold via a hydraulic or pneumatic motor connected to an output device, and in fluid communication with the hydraulic or pneumatic intake manifold via hydraulic pump or pneumatic compressor driven by a source of variable power; and
a governor or control valve disposed between the hydraulic or pneumatic exhaust manifold and the hydraulic or pneumatic motor connected to the output device, wherein the governor, the exhaust and the intake valves are actively or passively controlled, wherein the two or more pneumatic or hydraulic capacitors or accumulators form a mechanical pulse forming network by linking pneumatic or hydraulic capacitors or accumulators together that are fired in sequence and gas confined in air or hydraulic capacitors or accumulators acts as a spring when compressed by the hydraulic fluid or gas being pumped into the pneumatic or hydraulic capacitors or accumulators.

24. The device of claim 23, wherein the gas or hydraulic fluid is forced out of the pneumatic or hydraulic capacitors or accumulators through the outlet valves to drive the hydraulic or pneumatic motor.

25. The device of claim 23, wherein the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the air or hydraulic capacitors or accumulators are connected by high pressure lines.

26. The device of claim 23, wherein the hydraulic fluid reservoir is open to the atmosphere.

27. The device of claim 23, wherein the at least one of the hydraulic or pneumatic exhaust manifold, the hydraulic or pneumatic intake manifold, the hydraulic fluid or pneumatic reservoir, the hydraulic or pneumatic motor, the hydraulic pump or pneumatic compressor of the air or hydraulic capacitors or accumulators, the exhaust or intake valves, or the governor or control valve, are plastic.

28. The device of claim 23, wherein the output device driven by the hydraulic or pneumatic motor under the control of the governor or control valve provides a high quality power pulse to load.

29. The device of claim 23, wherein the source of variable power that drives the hydraulic pump or pneumatic compressor is at least one of solar, wind, wave, stored potential energy, springs, pendulums, stored water, or weights.

30. A mechanical energy storage device kit comprising:
two or more pneumatic or hydraulic capacitors or accumulators;
at least one hydraulic or pneumatic exhaust manifold;
a hydraulic or pneumatic intake manifold through exhaust and intake valves, respectively;
at least one hydraulic fluid or pneumatic reservoir;
at least one fluid hose that connects the hydraulic or pneumatic exhaust manifold to a hydraulic or pneumatic motor or pump;
an output device capable of connecting to the hydraulic or pneumatic motor or pump;
at least one fluid hose that connects the hydraulic or pneumatic intake manifold via hydraulic pump or pneumatic compressor driven by a source of variable power;
a governor or control valve that can be connected between the hydraulic or pneumatic exhaust manifold and the hydraulic or pneumatic motor connected to the output device; and
instructions to assemble the mechanical energy storage device.

31. A method of making a mechanical energy storage device comprising:
linking two or more pneumatic or hydraulic capacitors or accumulators, each of them connected to at least one hydraulic or pneumatic exhaust manifold and a hydraulic or pneumatic intake manifold through exhaust and intake valves, respectively;
connecting at least one hydraulic fluid or pneumatic reservoir in fluid communication with the hydraulic or pneumatic exhaust manifold via a hydraulic or pneumatic motor connected to an output device, and in fluid communication with the hydraulic or pneumatic intake manifold via hydraulic pump or pneumatic compressor driven by a source of variable power; and releasing the energy stored in the two or more pneumatic or hydraulic capacitors or accumulators via a governor or control valve disposed between the hydraulic or pneumatic exhaust manifold and the hydraulic or pneumatic motor connected to the output device, wherein the governor, the exhaust and the intake valves are passively controlled, wherein the two or more pneumatic or hydraulic capacitors or accumulators form a mechanical pulse forming network by linking pneumatic or hydraulic capacitors or accumulators together that are fired in sequence and gas in pneumatic or hydraulic capacitors or accumulators acts as a spring when compressed by the hydraulic fluid or gas being pumped into the pneumatic or hydraulic capacitors or accumulators, wherein the two or more pneumatic or hydraulic capacitors or accumulators form a mechanical pulse forming network by the linked pneumatic or hydraulic capacitors or accumulators together that are fired in sequence.
